(19) United States
(12) Patent Application Publication
(10) Pub. No.: US 2012/0099950 A1
(43) Pub. Date: Apr. 26, 2012

(54) SYSTEM AND METHOD FOR MANAGEMENT OF TRANSPORTATION DEVICE

(75) Inventors: Young Hak JEONG, Gunpo-si (KR); Bae Kyun KIM, Seongnam-si (KR); Senug Hyun RA, Seongnam-si (KR); Hyun Chul JUNG, Yongin-si (KR); Yong Wook KIM, Suwon-si (KR)

(73) Assignee: SAMSUNG ELECTRO-MECHANICS CO., LTD., Suwon-si (KR)

(21) Appl. No.: 13/274,685

(22) Filed: Oct. 17, 2011

(30) Foreign Application Priority Data
Oct. 21, 2010 (KR) 10-2010-0102788

(51) Int. Cl. B65G 47/74; H02J 7/00

(52) U.S. Cl. 414/222.01; 414/806

(57) ABSTRACT

Disclosed herein are a system for management of a transportation device, including: a plurality of work tables disposed to be spaced from each other; charging terminals provided around the work tables; and transportation devices transporting objects between the work tables and including a supercapacitor as a power supply, and a method therefor.

### CROSS REFERENCE(S) TO RELATED APPLICATIONS

This application claims the benefit under 35 U.S.C. Section 119 of Korean Patent Application Serial No. 10-2010-0102788, entitled “System and Method for Management of Transportation Device” filed on Oct. 21, 2010, which is hereby incorporated by reference in its entirety into this application.

### BACKGROUND OF THE INVENTION

1. Technical Field

The present invention relates to a system and a method for management of a transportation device, and more particularly, to a system for management of a transportation device including a supercapacitor as a power supply to freely select a moving path and improve efficiency of a charging process, thereby improving work efficiency, and a method therefor.

2. Description of the Related Art

A conveyor belt, an automatic guided vehicle, or the like, has been used in a work field such as a factory, etc., by an automation technology that has continuously advanced for several decades to improve productivity.

FIG. 1 is a diagram showing a system for management of automatic guided vehicles according to the related art.

Referring to FIG. 1, automatic guided vehicles (AGVs) 21, 22 and 23 serve to transport objects such as components, etc., along a rail provided between work tables 10.

Meanwhile, portions 57 to 60 indicated by oblique lines indicate areas in which charging may be performed, that is, charging stations. When the automatic guided vehicles performing work between the work tables have remaining capacity of a battery below a predetermined level, they are moved to the charging station to be charged. After charging is completed, the automatic guided vehicles are again disposed between the work tables, such that the system is managed.

However, the automatic guided vehicles according to the related art as described above require a lot of time to be charged as well as move to the charging station separately provided for charging after performing work for a predetermined time to be charged again for a long time. Therefore, the time at which each of the automatic guided vehicles may actually perform the work has been reduced, such that numerous works cannot be performed. As a result, in order to increase the work amount, more automatic guided vehicles have been operated.

Also, the automatic guided vehicles moving along the rail have been operated by being supplied with power from the power supply lines provided to the rail without a separate battery. However, in this scheme, there was a risk of an accident of getting an electric shock by the power supply lines provided to the rail as well as there was a problem that paths of the automatic guided vehicles are fixed, thereby having a difficulty in efficiently selecting carrying paths.

### SUMMARY OF THE INVENTION

An object of the present invention is to provide a system for management of a transportation device using a supercapacitor as a power supply to freely select a moving path and omit a separate process for charging, thereby making it possible to considerably improve utility and work efficiency of a transportation device and a method therefor.

According to an exemplary embodiment of the present invention, there is provided a system for management of a transportation device, including: a plurality of work tables disposed to be spaced from each other; charging terminals provided around the work tables; and transportation devices transporting objects between the work tables and including a supercapacitor as a power supply.

The charging terminals may be each provided around all of the plurality of work tables.

The charging terminals may be each provided around only some of the plurality of work tables.

The transportation device may include: moving portions for moving a position of the transportation device; a power supply including a supercapacitor for storing power and a charging terminal connector; and a controller controlling the moving portions and the power supply and monitoring the charging amount of the power supply.

According to another exemplary embodiment of the present invention, there is provided a method for management of a transportation device, including: (a) transferring or loading objects; (b) moving a transportation device to a destination; (c) charging a supercapacitor and transferring or loading the objects; and (d) moving the transportation device to a next destination.

Step (b) may include: (b-1) inputting the destination; and (b-2) moving the transportation device to the input destination.

The charging the supercapacitor in step (c) may include: (c-1) determining whether or not a charging terminal exists at the destination; (c-2) connecting a charging terminal connector to the charging terminal only when the charging terminal exists at the destination; and (c-3) separating the charging terminal connector from the charging terminal when the charging is completed.

According to another exemplary embodiment of the present invention, there is provided a method for management of a transportation device transporting objects between a plurality of work tables, including: moving a transportation device to a destination by inputting a destination to perform work in the case in which remaining capacity of power supply is a reference amount or more and inputting a destination in the case in which the remaining capacity of the power supply is below the reference amount; and confirming whether or not a charging terminal exists at the input destination and moving the transportation device to the input destination to perform work only when the charging terminal exists at the input destination.

The method for management of a transportation device may further include requesting to re-input a destination when the charging terminal does not exist at the input destination; and inputting the destination.

The reference amount may be 30 to 45% with respect to full charging of the supercapacitor.

### BRIEF DESCRIPTION OF THE DRAWINGS

FIG. 1 is a block diagram showing a configuration of a system for management of automatic guided vehicles according to the related art;

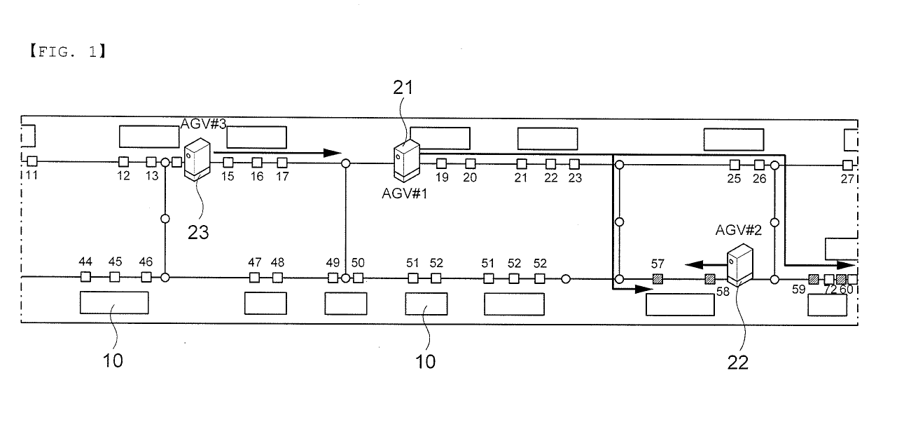

FIG. 2 a flow chart showing a method for management of automatic guided vehicles according to the related art;

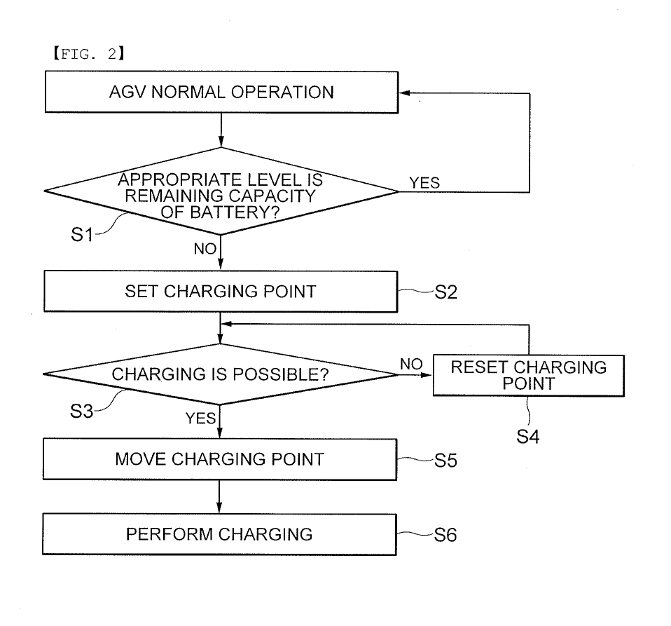

FIG. 3 is a block diagram showing a configuration of a system for management of a transportation device according to an exemplary embodiment of the present invention;

FIG. 4 is a schematic diagram showing a configuration of a transportation device according to an exemplary embodiment of the present invention;

FIG. 5 is a flow chart showing a method for management of a transportation device according to a first exemplary embodiment of the present invention;

FIG. 6 is a flow chart showing a method for management of a transportation device according to a second exemplary embodiment of the present invention; and

FIG. 7 is a flow chart showing a method for management of a transportation device according to a third exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the specification denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and operation of the present invention will be described in detail with reference to the accompanying drawings.

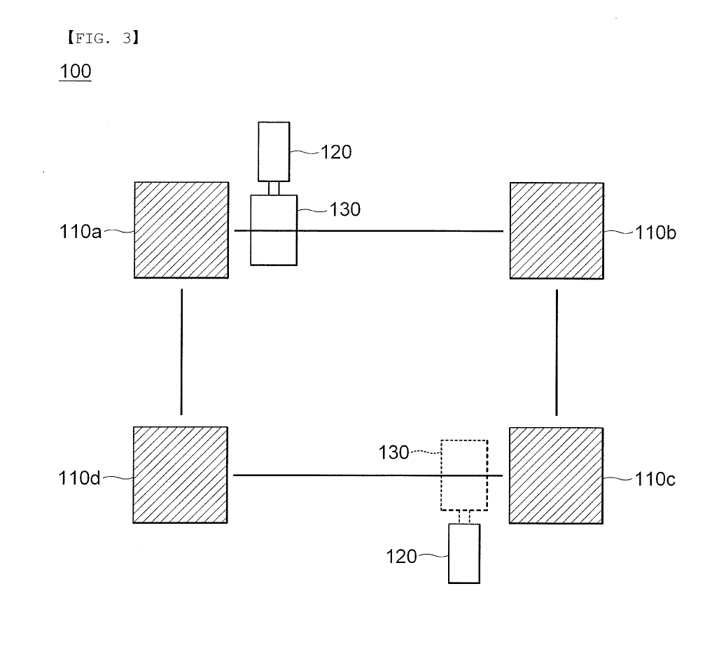

FIG. 3 is a block diagram showing a configuration of a system 100 for management of a transportation device according to an exemplary embodiment of the present invention. Referring to FIG. 3, a system 100 for management of a transportation device according to an exemplary embodiment of the present invention is configured to include work tables 100, charging terminals 120, and a transportation device 130.

The work table 110, which is a work area for performing general work, corresponds to an assembly line, various processing lines, or the like.

The charging terminal 120 serves to supply power capable of charging a power supply 133 of the transportation device 130. Although FIG. 3 shows a case where the charging terminals 120 are provided around two work tables 110 of four work tables 110, the present invention is not limited thereto. That is, the charging terminals 120 may be provided around all of the work tables 110. In order to reduce system cost, points at which charging may be efficiently performed for each moving distance and for each frequency are selected and the charging terminals may be provided to the points.

The transportation device 130 serves to transport objects such as components, raw materials, and the like, between the work tables 110. The transportation device 130 according to the exemplary embodiment of the present invention includes a supercapacitor 133a as the power supply 133.

The supercapacitor 133a, which is also referred to as an ultra capacitor, has been spotlighted as the next-generation energy storage device due to more rapid charging and discharging speed, higher stability, and environment-friendly characteristics as compared to a general secondary battery according to the related art. The supercapacitor as described above has advantages in that it has lower energy density and several tens to several hundreds times higher power density as compared to the lithium ion secondary battery and has charging and discharging lifetime of several hundred thousands of times as well as very rapid charging and discharging speed in a degree that complete charging may be performed within only several seconds.

Since the transportation device 130 according to the exemplary embodiment of the present invention includes the supercapacitor 133a as the power supply 133, it uses current discharged from the supercapacitor 133a when it is moved between the work tables 110 and it is connected to the charging terminal to be charged 120 when arriving at the work table 110. Therefore, the transportation device 130 transfers or loads the object.

In addition, since the charging of the supercapacitor 133a is completed within short time, although it is charged only during the time when the transportation device 130 stays at the work table 110 for a moment, the supercapacitor may be sufficiently charged.

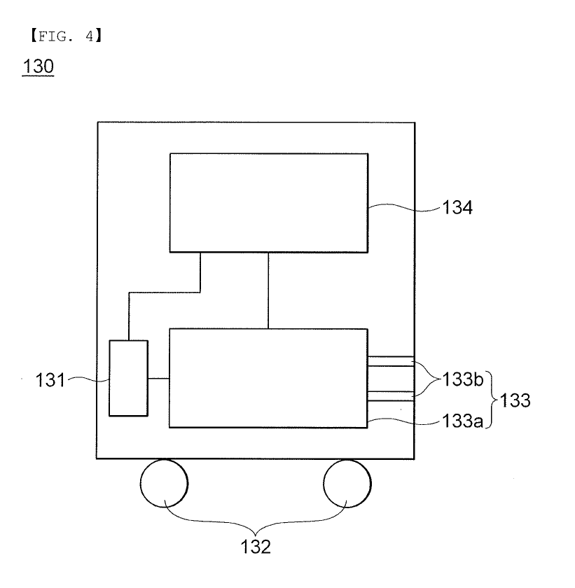

FIG. 4 is a schematic diagram showing a configuration of a transportation device according to an exemplary embodiment of the present invention.

Referring to FIG. 4, the transportation device 130 may be configured to include moving portions 131 and 132, the power supply 133 and a controller 134. Components required for transferring and loading the objects may be easily provided by existing general technologies. Therefore, the detailed description thereof will be omitted.

The moving portion may be implemented as a motor 131, wheels 132, and the like.

The power supply 133 may be configured to include an energy storage formed of the supercapacitor 133a and a charging terminal connector 133b.

The supercapacitor 133a may be implemented as a module formed by connecting a plurality of unit cells in series or in parallel and may be appropriately applied according to the capacity of the power supply required in the transportation device 130.

The controller 134 serves to control the power supply 133 and the moving portions to move the transportation device 130 and manage the power.

In particular, the controller 134 may monitor energy stored in the supercapacitor 133a of the power supply 133 in real time and inform that charging is required using a warning sound, a warning lamp, or the like, when the stored energy is reduced below a predetermined reference value according to a result of the monitoring.

When the charging terminals 120 are mounted around some of the work tables 110, in the case in which the charging amount of the transportation device is below a predetermined level, the controller 134 may determine whether or not the charging terminal 120 exists at the destination to which the transportation device will be moved and control move the transportation device to move to the work table 110 at which the charging terminal 120 exists.

Hereinafter, a method for management of a transportation device 130 according to an exemplary embodiment of the present invention will be described in detail.

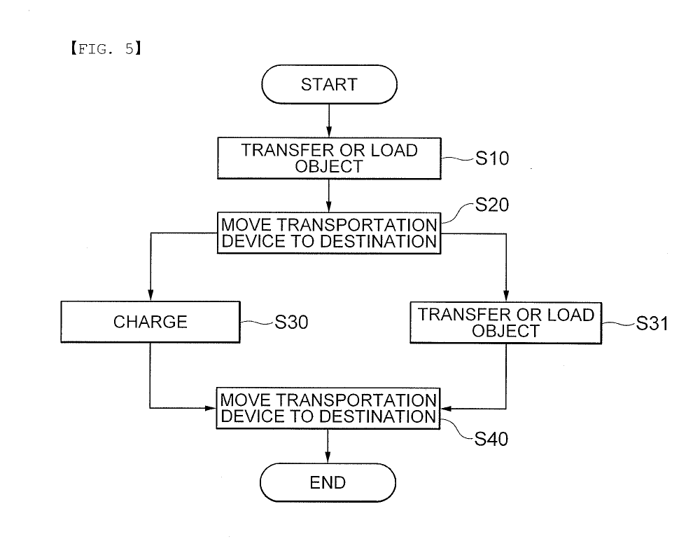

FIG. 5 is a flow chart showing a method for management of a transportation device 130 according to a first exemplary embodiment of the present invention.

Referring to FIG. 5, a method for management of a transportation device 130 according to a first exemplary embodiment of the present invention may include transferring or loading objects (S10), moving the transportation device to a destination (S20), charging a battery (S30), transferring or loading the objects (S31), and moving the transportation device to a next destination (S40). At this time, the charging the battery and the transferring or loading the objects may be simultaneously or sequentially performed. In addition, in order to perform other operations while charging the battery, the charging terminal connector 133b may be provided with power supply lines separately from lines connected to the supercapacitor 133a.

The above embodiment may be applied to the case in which the charging terminals 120 are provided to all of the work tables 110 and the destination is preset.

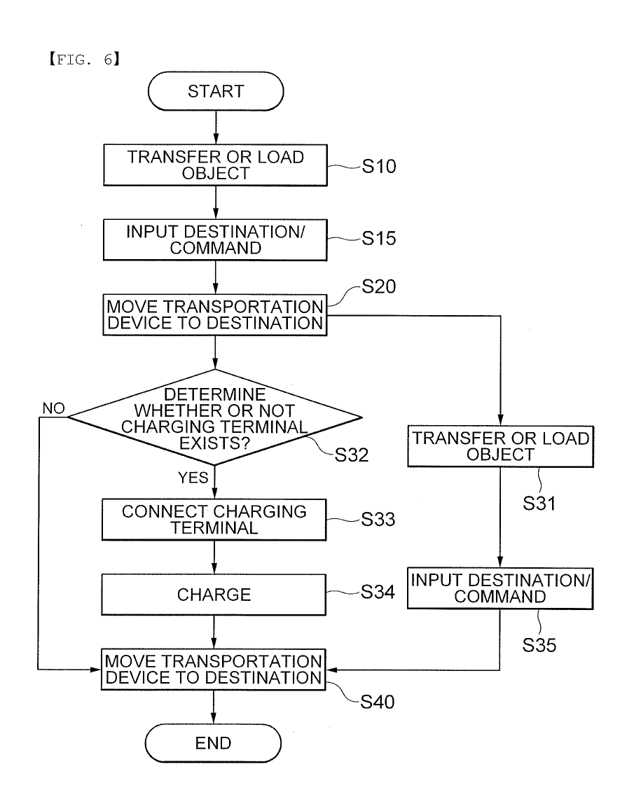

Next, FIG. 6 is a flow chart showing a method for management of a transportation device 130 according to a second exemplary embodiment of the present invention. A method for management of a transportation device 130 according to a second exemplary embodiment of the present invention may include transferring or loading objects (S10), inputting a destination to command movement of the transportation device (S15), and moving the transportation device to the destination (S20). At this time, the inputting the destination may be performed before transferring or loading the objects or may be performed simultaneously with transferring or loading the objects.

Unlike the method for management of a transportation device according to the first exemplary embodiment of the present invention, the method for management of a transportation device according to the second exemplary embodiment of the present invention further includes inputting a destination.

Unlike the automatic guided vehicle according to the related art in that the transportation device 130 should be moved along the rail, the method for management of a transportation device 130 according to the exemplary embodiment of the present invention sufficiently uses the advantage that the transportation device 130 may be freely moved. It may be usefully used in the case of moving the transportation device 130 to the destination set by the worker as needed, rather than a preset path or destination order.

Meanwhile, when the charging terminals 120 are provided to only some of the work tables 110, the method for management of a transportation device according to the second exemplary embodiment of the present invention may further include determining whether or not the charging terminal 120 exists (S32), and connecting the charging terminal 120 thereto (S33), thereby making it possible to perform the charging.

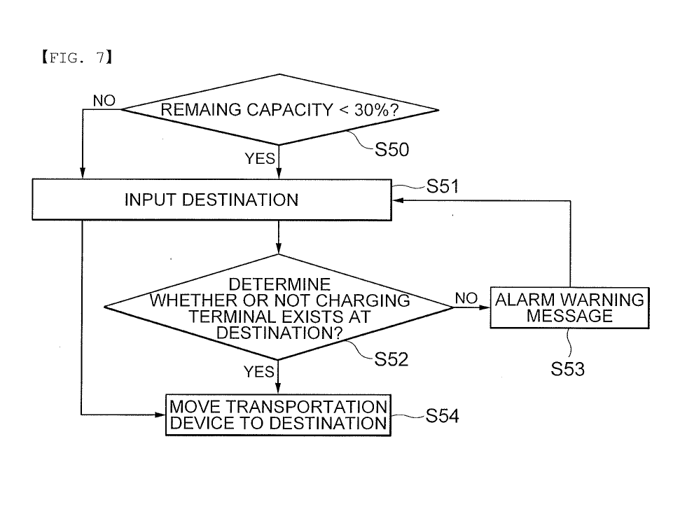

FIG. 7 is a flow chart showing a method for management of a transportation device 130 according to a third exemplary embodiment of the present invention. The controller 134 sets a reference amount when monitoring the charging amount of the supercapacitor 133a, determines whether or not the charging terminal 120 exists at the destination when the charging amount is below the reference amount, and outputs a warning sound, a warning lamp, or the like, when the charging terminal 120 does not exist at the destination to re-input the destination, thereby making it possible to previously prevent a problem that the supercapacitor 133a is completely discharged to stop operation.

At this time, the reference amount may be set to about 30 to 45% with respect to full charging of the supercapacitor 133a in consideration of a distance between the work tables 110, an arrangement of the charging terminal 120, and the like.

As set forth above, the present invention may perform charging using the charging terminal provided to the work table, such that the transportation device needs not to be moved to a separate charging station, thereby improving work efficiency of the transportation device.

In addition, the present invention needs not to be supplied with power by the rail, etc., such that the moving path may be freely selected, thereby making it possible to reduce the time required for the movement of the transportation device and freely select the arrangement of the work table.

The present invention has been described in connection with what is presently considered to be practical exemplary embodiments. Although the exemplary embodiments of the present invention have been described, the present invention may also be used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. A system for management of a transportation device, comprising:
a plurality of work tables disposed to be spaced from each other;
charging terminals provided around the work tables; and
transportation devices transporting objects between the work tables and including a supercapacitor as a power supply.

2. The system for management of a transportation device according to claim 1, wherein the charging terminals are each provided around all of the plurality of work tables.

3. The system for management of a transportation device according to claim 1, wherein the charging terminals are each provided around only some of the plurality of work tables.

4. The system for management of a transportation device according to claim 1, wherein the transportation device includes:
moving portions for moving a position of the transportation device;
a power supply including a supercapacitor for storing power and a charging terminal connector; and
a controller controlling the moving portions and the power supply and monitoring the charging amount of the power supply.

5. A method for management of a transportation device, comprising:
(a) transferring or loading objects;
(b) moving a transportation device to a destination;
(c) charging a supercapacitor and transferring or loading the objects; and
(d) moving the transportation device to a next destination.

6. The method for management of a transportation device according to claim 5, wherein step (b) includes:
(b-1) inputting the destination; and
(b-2) moving the transportation device to the input destination.

7. The method for management of a transportation device according to claim 5, wherein the charging the supercapacitor in step (c) includes:
(c-1) determining whether or not a charging terminal exists at the destination;
(c-2) connecting a charging terminal connector to the charging terminal only when the charging terminal exists at the destination; and
(c-3) separating the charging terminal connector from the charging terminal when the charging is completed.

8. A method for management of a transportation device transporting objects between a plurality of work tables, comprising:
moving a transportation device to a destination by inputting a destination to perform work in the case in which remaining capacity of power supply is a reference amount or more and inputting a destination in the case in which the remaining capacity of the power supply is below the reference amount; and
confirming whether or not a charging terminal exists at the input destination and moving the transportation device to the input destination to perform work only when the charging terminal exists at the input destination.

9. The method for management of a transportation device according to claim 8, further comprising:
requesting to re-input a destination when the charging terminal does not exist at the input destination; and
inputting the destination.

10. The method for management of a transportation device according to claim 8, wherein the reference amount is 30 to 45% with respect to full charging of the supercapacitor.
